(19) United States
(12) Patent Application Publication
(10) Pub. No.: US 2026/0148566 A1
(43) Pub. Date: May 28, 2026

(54) MOBILE VEHICLE SENSOR FUSION SYSTEM AND METHOD THEREOF

(71) Applicant: Metal Industries Research & Development Center, Kaohsiung (TW)

(72) Inventors: Tsung-Han Lee, Kaohsiung (TW); Jinn-Feng Jiang, Kaohsiung (TW); Shih-Chun Hsu, Kaohsiung (TW); Tsu-Kun Chang, Kaohsiung (TW); Hung-Yuan Wei, Kaohsiung (TW); Cheng-Tai Lei, Kaohsiung (TW)

(21) Appl. No.: 19/262,930

(22) Filed: Jul. 8, 2025

(30) Foreign Application Priority Data
Nov. 26, 2024 (TW) 113145580

(51) Int. Cl. G06V 20/58; B60W 30/09; B60W 50/14; G06V 10/80

(52) U.S. Cl. CPC G06V 20/58; B60W 30/09; B60W 50/14; G06V 10/803; B60W 2050/143; B60W 2554/4042; B60W 2554/80

(57) ABSTRACT

The present application provides a mobile vehicle sensor fusion system and a method thereof, applied to a vehicle moving at a movement speed. An optical scan unit and an image extraction unit extract and transmit a first scan image and a first ambient image of a first detection zone and a second detection zone surrounding the vehicle to a host for obtaining a first image and obtaining an obstacle image within the first image, thereby, extracting an obstacle information of an obstacle from the obstacle image and obtaining a relative distance between the vehicle and the obstacle for judging whether the obstacle is located in the first detection zone close to the vehicle or the second detection zone outside the first detection zone. A first assistance message is produced corresponding to the obstacle in the first detection zone for preventing the driver from ignoring danger.

### BACKGROUND OF THE INVENTION

Traditional advanced driver assistance systems (ADAS) are developed to assist drivers and may essentially be divided into three main parts: vehicle sensors, a vehicle processor, and actuators. ADAS uses vehicle sensors to sense signals outside of vehicles. In addition to millimeter-wave radars and lidars, vehicle sensors include thermal and pressure sensors as well. The vehicle sensors transmit sensing data to the vehicle processor, for example, an electronic control unit (ECU). Then the vehicle processor may produce alarm information recognizable by drivers to avoid dangerous road conditions. The vehicle sensors may even intervene in driver's driving behavior in off-guard situations and start the actuators for providing protective functions such as decelerating, emergency brake, or redirecting the vehicle.

Furthermore, nowadays, to protect drivers, the radar detection technology has been developed for detecting the surroundings of a vehicle. Unfortunately, radars cannot differentiate between fixed and moving obstacles around a vehicle. Besides, even when obstacles are detected merely approaching the vehicle, the alarm unit is still driven to submit alarm messages, which annoys the driver. Thereafter, there are many improvements in detecting obstacles surrounding a mobile vehicle and achieving obstacle monitoring. Nonetheless, in the moving process of a mobile vehicle, ignoring any obstacle by the driver will lead to accidents. This situation is particularly severe in the streets of a city. Once the driver overlooks any obstacle, such as streetlamps, overtaking vehicles, pedestrians crossing the road, traffic islands, traffic lights or guiding lights at corners, or billboards on the street, accidents will occur.

Although there are color image extraction technologies, for example, dashcams, for recording accidents used for post judgement, this recording method is not the ultimate solution. It is therefore urged to provide preventive measures for drivers to avoid accidents in advance. Besides, current automotive radars are installed only on the front and rear sides of a vehicle. Novel vehicles will further integrate lateral image equipment and detection technologies for assisting drivers to avoid emergency situations caused by lateral blind spots, and further protect drivers by predicting danger and notifying drivers according to the detection of lateral blind spots.

Nonetheless, drivers need a response time to handle situations in vehicle movement. Drivers further need to pay attention to obstacles particularly in the modern day of pervasive autopilot technology. Not only is it protecting drivers by intervention, but it is also required to predict dangers around a vehicle beforehand and rapidly.

To solve the above problems, the present application provides a mobile vehicle sensor fusion system and the method thereof. According to the present application, by acquiring a first scan image on a side of a vehicle and a first ambient image, a corresponding first image will be obtained. From the first image, an obstacle image will be extracted. According to the obstacle image, the obstacle information of the obstacle may be obtained. Consequently, it may be judged whether the obstacle is located in a first detection zone approximate to the vehicle or a second detection zone outside the first detection zone. Moreover, when the obstacle is judged to be located in the first detection zone according to a distance threshold and a relative distance in the obstacle information, produce a corresponding first assistance message for the driver according to the obstacle information to avoid accidents.

### SUMMARY OF THE INVENTION

An objective of the present application is to provide a mobile vehicle sensor fusion system and the method thereof. Performing a fusion algorithm to obtain a first scan image on a side of a vehicle and a first ambient image to obtain a first image. Extract an obstacle image from the first image and then extract obstacle information of the obstacle. According to the obstacle information, a relative distance between the vehicle and the obstacle will be obtained. Then, according to a distance threshold, whether the obstacle is located in a first detection zone approximate to the vehicle or a second detection zone outside the first detection zone may be judged. When the obstacle is judged to be in the first detection zone, produce a corresponding first assistance message for the driver according to the obstacle information to avoid accidents.

To achieve the above objective, the present application discloses a mobile vehicle sensor fusion method applied to a vehicle moving at a movement speed. The vehicle includes a host, an optical scan unit, and an image extraction unit. The host is connected electrically to the optical scan unit and the image extraction unit. The mobile vehicle sensor fusion method according to the present application comprises steps of: first, using the optical scan unit extracting a first scan image according to a first detection zone and a second detection zone of the vehicle, the image extraction unit extracting a first ambient image according to the first detection zone and the second detection zone on the side of the vehicle, and the optical scan unit and the image extraction unit transmitting the first scan image and the first ambient image to the host, wherein the first detection zone is located between the vehicle and the second detection zone; then, using the host executing a fusion algorithm according to the first scan image and the first ambient image for obtaining a first image, wherein the first image includes a first image zone and a second image zone with the first image zone corresponding to the first detection zone and the second image zone corresponding to the second detection zone; next, using the host executing an image optical flow algorithm according to the first image for obtaining an obstacle image, and obtaining obstacle information of an obstacle according to the obstacle image; then, using the host obtaining a movement vector and an acceleration vector of the obstacle and a relative distance between the obstacle and the vehicle according to the obstacle information, and judging whether the obstacle is located in the first detection zone or the second detection zone surrounding the vehicle according to the relative distance and a distance threshold, wherein the movement vector corresponds to a relative speed of the obstacle with respect to the vehicle and a movement direction of the obstacle; furthermore, when the relative distance is smaller than or equal to the distance threshold and the obstacle is judged to be in the first detection zone since the obstacle image is located in the first image zone, using the host producing a first alarm message corresponding to the obstacle according to the movement speed of the vehicle and the movement vector and the acceleration vector of the obstacle. Accordingly, the present application provides danger prediction on a side of a moving vehicle and produces the corresponding assistance message. Thereby, the present application may be applied to a driver assistance system for intervening in driving control according to the assistance message and notifying the driver concurrently. Alternatively, the present application may be applied to warning the driver of obstacles in advance for avoiding accidents.

According to an embodiment of the present application, in the step of using the host producing a first alarm message corresponding to the obstacle according to the movement speed of the vehicle and the movement vector and the acceleration vector of the obstacle, when the movement speed is smaller than the relative speed, the host further produces a brake prompt message to remind the driver of immediate braking for avoiding accidents. In addition, when the movement speed is greater than the relative speed, the host further drives the vehicle to brake, even if the driver is unable to react to brake, for preventing the vehicle from bumping into the obstacle.

According to an embodiment of the present application, in the step of using the host obtaining a relative distance between the obstacle and the vehicle according to the obstacle information and judging whether the obstacle is located in the first detection zone or the second detection zone surrounding the vehicle according to the movement speed, the relative distance, and a distance threshold, the host extracts a positioning message corresponding to the obstacle according to the obstacle information for obtaining the relative distance between the obstacle and the vehicle.

According to an embodiment of the present application, in the step of using the host obtaining a relative distance between the obstacle and the vehicle according to the obstacle information and judging whether the obstacle is located in the first detection zone or the second detection zone of the vehicle according to the relative distance and a distance threshold, the distance threshold is 5 to 10 meters. In other words, this distance threshold differentiates the first detection zone and the second detection zone.

According to an embodiment of the present application, furthermore, when the relative distance is greater than the distance threshold and the obstacle is judged to be in the second detection zone since the obstacle image is located in the second image zone, the host produces a second alarm message corresponding to the obstacle according to the movement speed of the vehicle and the movement vector of the obstacle. The alarm level of the second alarm message is lower than that of the first alarm message, indicating an alarm message with a lower degree of warning. Besides, the host consumes less operational resources thanks to fewer parameters.

The present application further provides a mobile vehicle sensor fusion system. The vehicle is moving at a movement speed. The mobile vehicle sensor fusion system comprises a host, an optical scan unit, and an image extraction unit. The host is disposed in the vehicle. The optical scan unit and the image extraction unit are disposed on a side of the vehicle and connected electrically to the host. The optical scan unit and the image extraction unit extract and transmit a first scan image and a first ambient image according to a first detection zone and a second detection zone surrounding the vehicle to the host. The first detection zone is located between the vehicle and the second detection zone. The host executes a fusion algorithm according to the first scan image and the first ambient image for obtaining a first image. The first image includes a first image zone and a second image zone with the first image zone corresponding to the first detection zone and the second image zone corresponding to the second detection zone. The host executes an image optical flow algorithm according to the first image for obtaining an obstacle image and obtaining obstacle information of an obstacle according to the obstacle image. The host obtains a movement vector and an acceleration vector of the obstacle and a relative distance between the obstacle and the vehicle according to the obstacle information, and judges whether the obstacle is located in the first detection zone or the second detection zone surrounding the vehicle according to the relative distance and a distance threshold. When the relative distance is smaller than or equal to the distance threshold and the obstacle is judged to be in the first detection zone since the obstacle image is located in the first image zone, the host produces a first alarm message corresponding to the obstacle according to the movement speed of the vehicle and the movement vector and the acceleration vector of the obstacle. Accordingly, the host predicts if the obstacle will influence the movement direction of the vehicle according to the first alarm message. Thereby, the driver assistance system may be notified for intervention or the driver may be notified.

According to another embodiment of the present application, the distance threshold is 5 to 10 meters.

According to another embodiment of the present application, when the movement speed is smaller than the relative speed, the host further produces a brake prompt message to remind the driver of immediate braking for avoiding accidents. In addition, when the movement speed is greater than the relative speed, the host further drives the vehicle to brake, even if the driver is unable to react to brake, for preventing the vehicle from bumping into the obstacle.

According to another embodiment of the present application, the host extracts a positioning message corresponding to the obstacle according to the obstacle information for obtaining the relative distance between the obstacle and the vehicle.

According to an embodiment of the present application, when the relative distance is greater than the distance threshold and the obstacle is judged to be in the second detection zone since the obstacle image is located in the second image zone, the host produces a second alarm message corresponding to the obstacle according to the movement speed of the vehicle and the movement vector of the obstacle. The alarm level of the second alarm message is lower than that of the first alarm message.

### BRIEF DESCRIPTION OF DRAWINGS

FIG. 1 shows a flowchart according to an embodiment of the present application;

FIG. 2A to FIG. 2G show schematic diagrams of the mobile vehicle sensor fusion system according to an embodiment of the present application;

FIG. 3A shows a schematic diagram of the detection zones according to an embodiment of the present application;

FIG. 3B shows a schematic diagram of the perspective projection method according to an embodiment of the present application;

FIG. 4A shows a schematic diagram of obstacle located in the first detection zone according to an embodiment of the present application; and

FIG. 4B shows a schematic diagram of obstacle located in the second detection zone according to an embodiment of the present application.

### DETAILED DESCRIPTION OF THE INVENTION

In order to make the structure and characteristics as well as the effectiveness of the present application to be further understood and recognized, the detailed description of the present application is provided as follows along with embodiments and accompanying figures.

In view of the inability to provide obstacle prediction by the radar systems and dashcams according to the prior art, the present application proposes a mobile vehicle fusion system and the method thereof for solving the problem of obstacle avoidance for drivers.

In the following, the properties of the mobile vehicle sensor fusion system and the method thereof disclosed in the present application will be further illustrated.

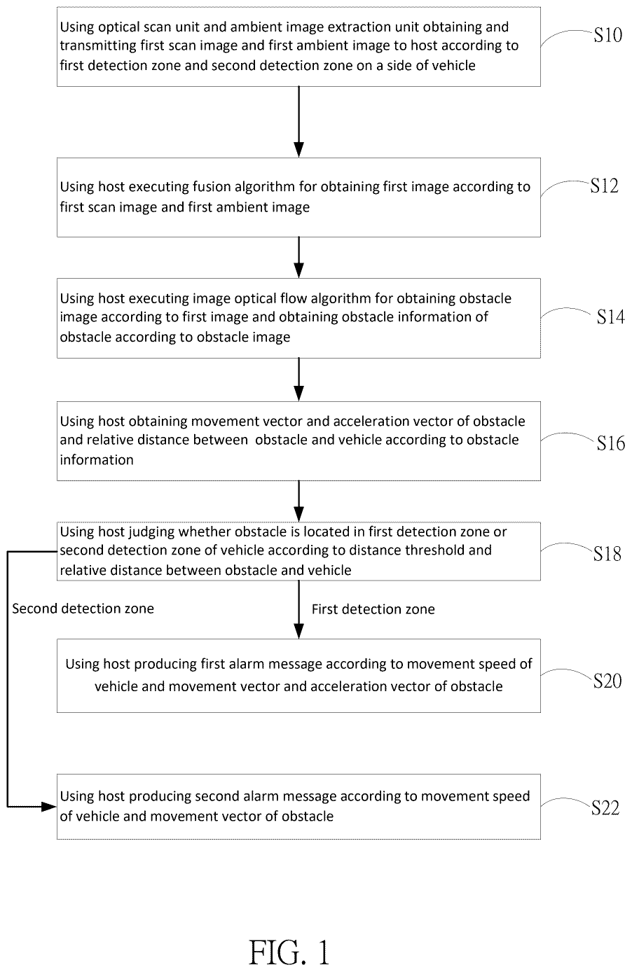

First, please refer to FIG. 1, which shows a flowchart according to an embodiment of the present application. As shown in the figure, the mobile vehicle sensor fusion method according to the present application comprises steps of:
Step S10: Using optical scan unit and image extraction unit obtaining and transmitting first scan image and first ambient image to host according to first detection zone and second detection zone surrounding vehicle;
Step S12: Using host executing fusion algorithm for obtaining first image according to first scan image and first ambient image;
Step S14: Using host executing image optical flow algorithm for obtaining obstacle image according to first image and obtaining obstacle information of obstacle according to obstacle image;
Step S16: Using host obtaining movement vector and acceleration vector of obstacle and relative distance between obstacle and vehicle according to obstacle information;
Step S18: Using host judging whether obstacle is located in first detection zone or second detection zone surrounding vehicle according to distance threshold and relative distance between obstacle and vehicle; and
Step S20: Using host producing first alarm message according to movement speed of vehicle and movement vector and acceleration vector of obstacle.

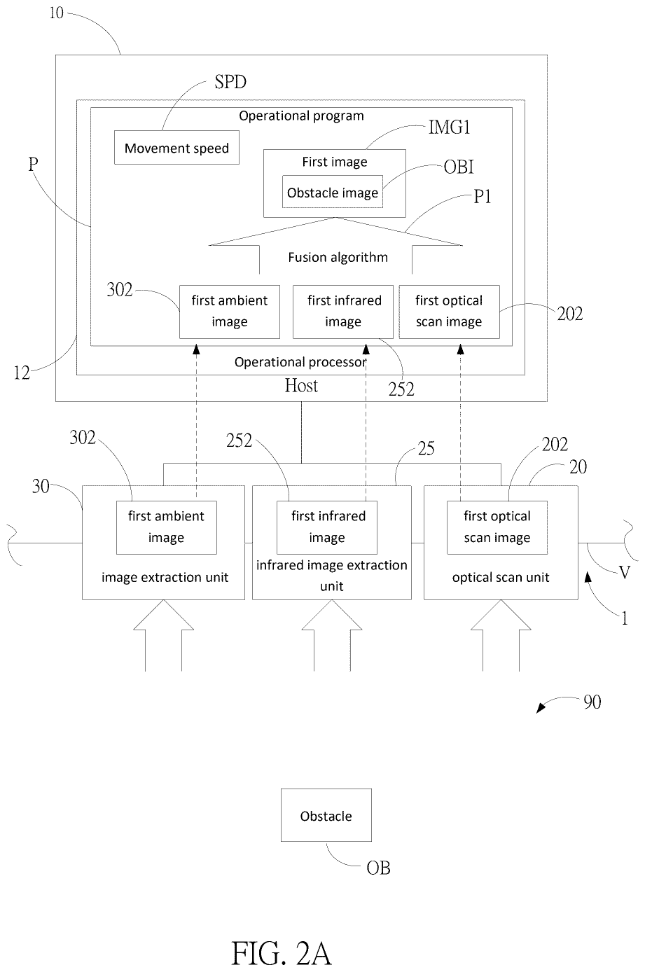

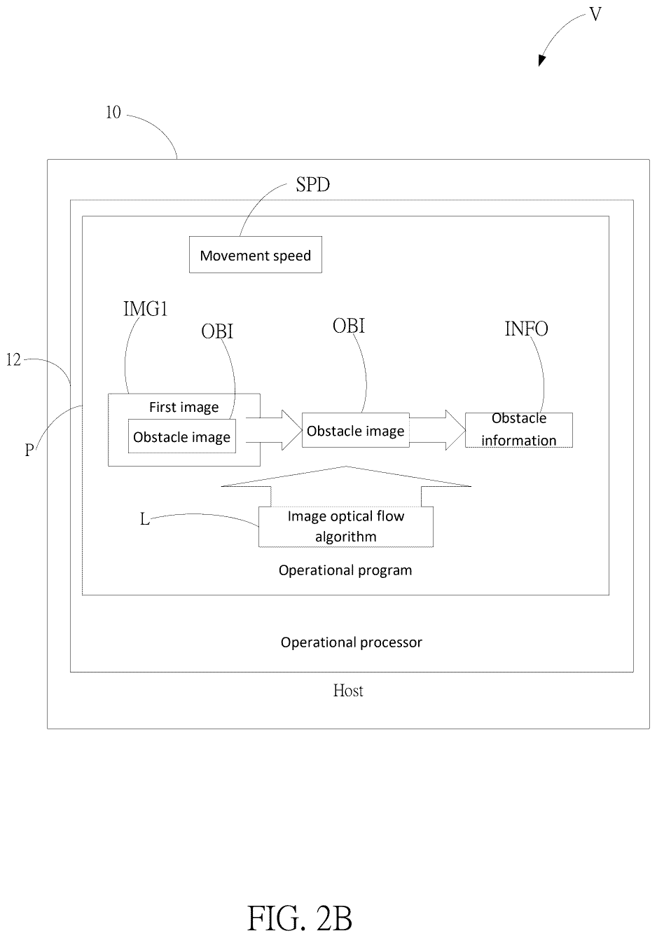

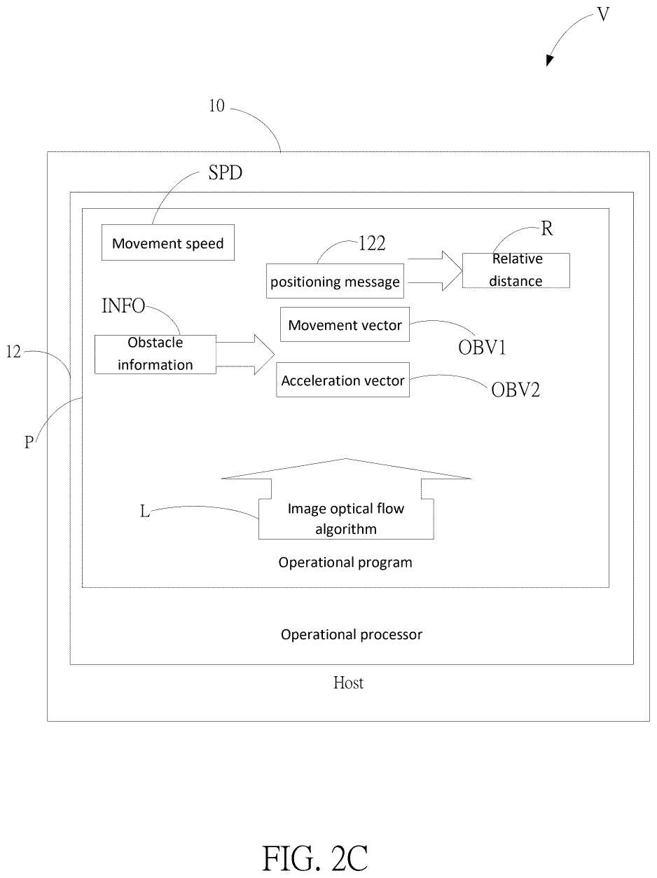

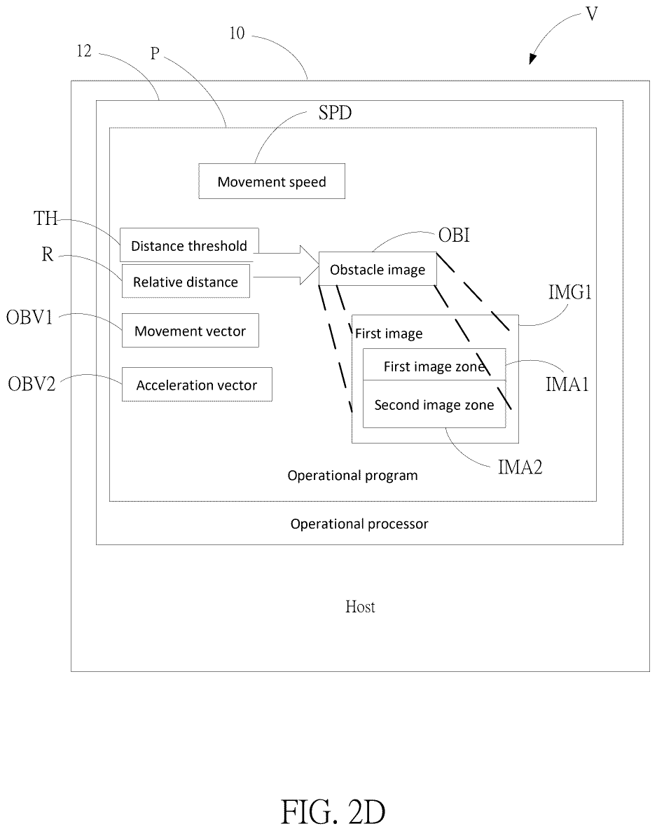

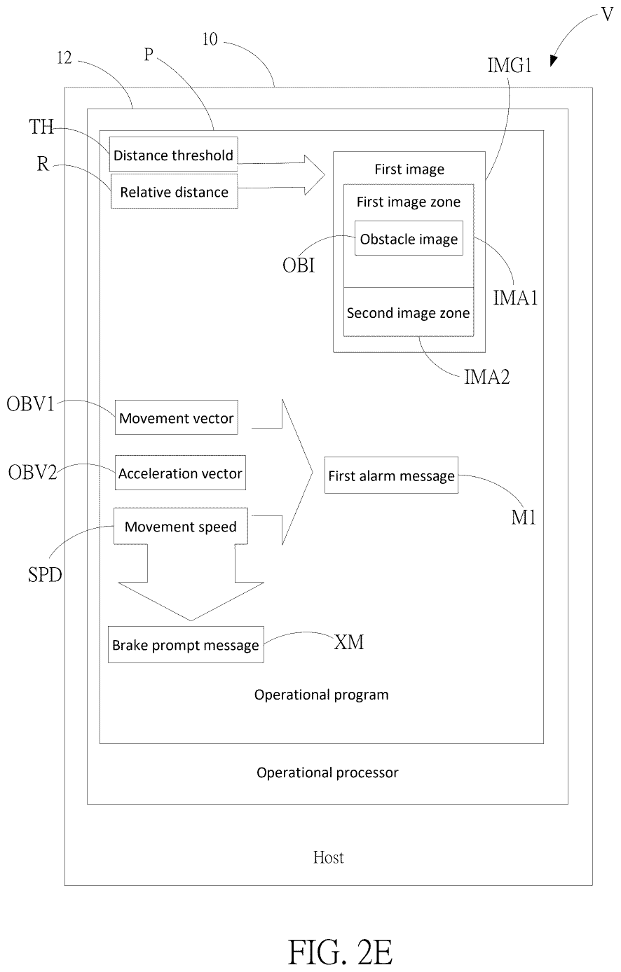

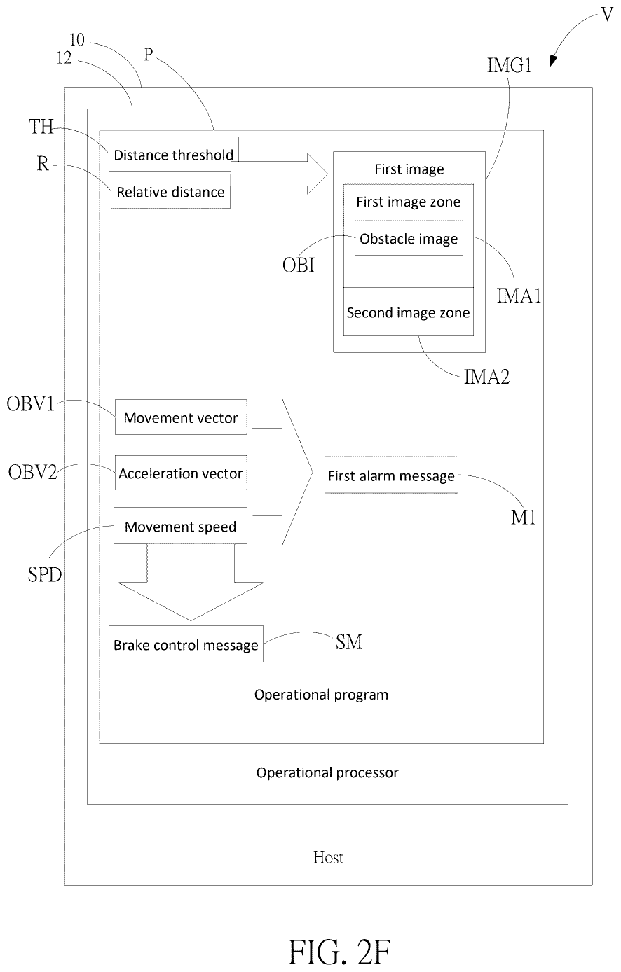

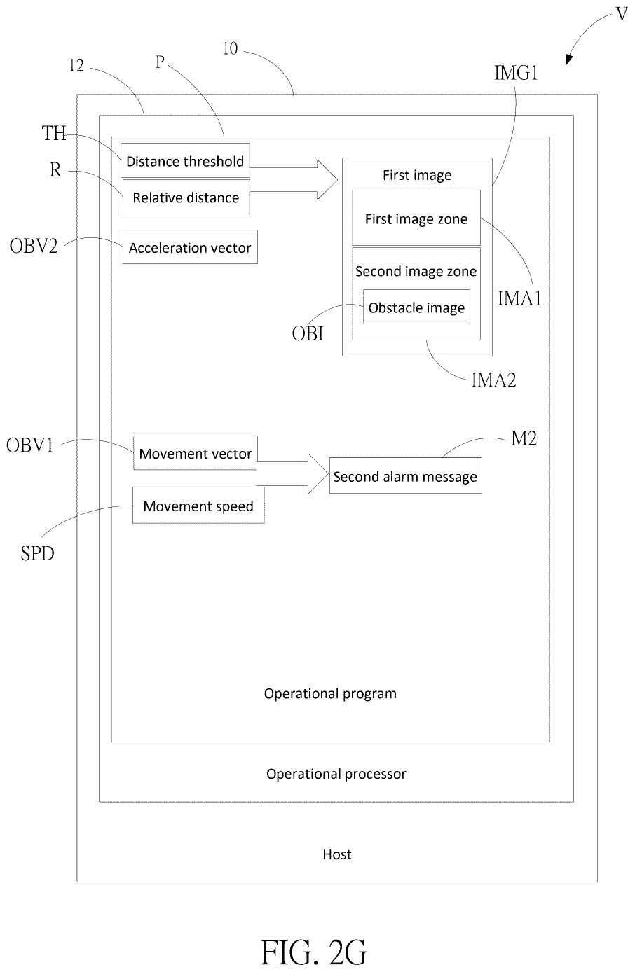

Please refer to FIG. 2A to FIG. 2G, which show the mobile vehicle sensor fusion system 1 utilizing the mobile vehicle sensor fusion method according to the present application. The mobile vehicle sensor fusion system 1 comprises a host 10, an optical scan unit 20, an infrared image extraction unit 25, and an image extraction unit 30. The host 10 according to the present embodiment is an automotive computer with an operational processor 12. Nonetheless, the present application is not limited to the example. The host 10 may alternatively be a server, a notebook computer, a tablet computer, or any electronic device having image processing capability. The operational processor 12 may be system-on-chip (SOC), a microprocessor (uP), a microcontroller (MCU), a programmable logic controller (PLC), a central processing unit (CPU), or a graphics processing unit (GPU). The optical scan unit 20 according to the present embodiment is a lidar or a laser scanner, which achieves the same effect of a lidar by multiple laser scans. The infrared image extraction unit 25 is a near-infrared (NIR) image sensor, a short-wavelength infrared (SWIR) image sensor, or a long-wavelength infrared (LWIR) image sensor. The image extraction unit 30 according to the present embodiment is a general visible-light image extraction unit, such as an automotive CMOS image sensor. The host 10 is disposed in a vehicle V. The optical scan unit 20 and the image extraction unit 30 are disposed on a side of the vehicle V. The host 10 is connected electrically to the optical scan unit 20 and the image extraction unit 30. The range of the image extraction angle of the image extraction unit 30 according to the present embodiment is 120 degrees to 180 degrees. The image extraction unit 30 extracts the ambient images, for example, object images, within the range of 10 to 30 meters, as described in more detail later.

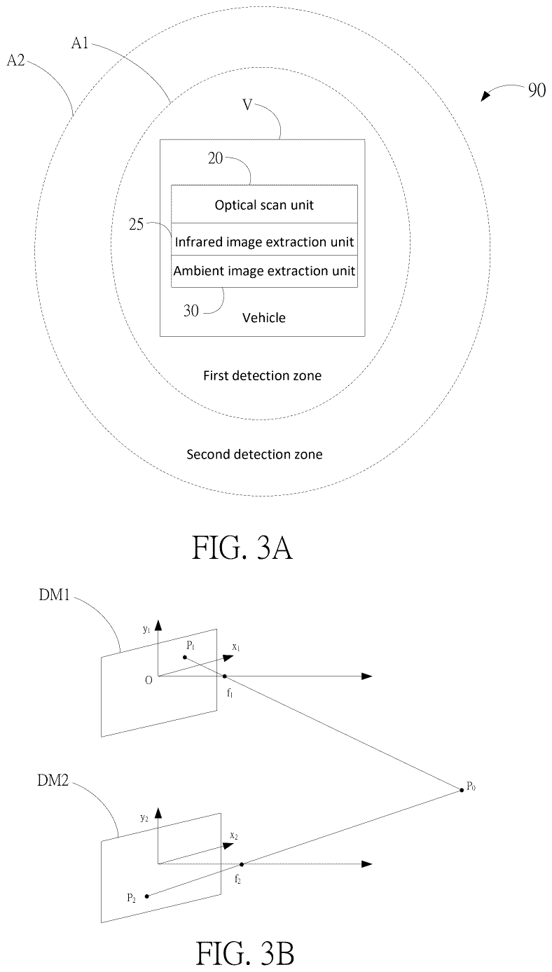

In the step S10, as shown in FIG. 2A, according to the present application, the optical scan unit 20 is used to perform optical scanning on the ambience 90 of a side of the vehicle V or even 10 meters to 50 meters around the vehicle V. According to the scanning result, a first optical scan image 202 will be obtained. In addition, the infrared image extraction unit 25 and the image extraction unit 30 extract a first infrared image 252 and a first ambient image 302 of the ambience 90 on a side of the vehicle V. As shown in FIG. 3A, the optical scan unit 20, the infrared image extraction unit 25, and the image extraction unit 30 correspondingly obtain the first optical scan image 202, the first infrared image 252, and the first ambient image 302 according to a first detection zone A1 and a second detection zone A2 of the vehicle V. The first detection zone A1 is located between the vehicle V and the second detection zone A2. That is to say, the first detection zone A1 is closer to the vehicle V, and the second detection zone A2 is located outside the first detection zone A1. For example, the first detection zone A1 is an inner ring area close to a side of the vehicle V; the second detection zone A2 is an outer ring area adjacent to the first detection zone A1.

Besides, as shown in FIG. 2A, the first detection zone A1 and the second detection zone A2 further encompass all blind spots, which are located on a side of the vehicle V, and compliant with the intelligent transport system standard ISO 17387. The optical scan unit 20 particularly focuses on the blind spots not visible from the vehicle V, namely, the blind spots outside the front visual regions of the driver. Even if the vehicle V is equipped with left and right rearview mirrors, it still needs the auxiliary optical scan unit 20, the infrared image extraction unit 25, and the image extraction unit 30 to extract the images not visible by the driver. Moreover, the ADAS also needs more complete image extraction before it may identify faultlessly if obstacles exist on a side of the vehicle V. The obstacles include any hindrance frequently appear at the blind spots, for example, humans, cars, bus stops, traffic boards, traffic lights, or even the A pillars of a car.

As shown in FIG. 3B, by using the perspective projection method, the image point P₀ in the ambient image extracted by the infrared image extraction unit 25 and the image extraction unit 30 may be divided into the first image point P₁ and the second image point P₂. The coordinates (x, y) of the first image point P₁ is located in the first region DM1; the coordinates (x′, y′) of the second image point P₂ is located in the second region DM2. Thereby, the relationship between the infrared image extraction unit 25 and the image extraction unit 30 extracting the first image point P₁ and the second image point P₂ may be expressed as the following two equations:

$${x}^{′} = \frac{{m}_{0} x + {m}_{1} y + {m}_{2}}{{m}_{6} x + {m}_{7} y + 1} \qquad ( 1 )$$

$${y}^{′} = \frac{{m}_{3} x + {m}_{4} y + {m}_{5}}{{m}_{6} x + {m}_{7} y + 1} \qquad ( 2 )$$

(x, y) is the first image point P₁; (x′, y′) is the second image point P₂; m₀, m₁, . . . m₇ are the parameters such as related focal length, rotational angle, and scaling of the infrared image extraction unit 25 and the image extraction unit 30. They may be extended to a plurality of image-point pairs. Then a nonlinear minimization operation is performed by using the Levenberg-Marquardt algorithm to obtain the optimum values of m₁ to m₇, which may be used as the optimum extraction focal length of the image extraction unit 30, for example, 10 mm to 100 mm.

Please refer to FIG. 1 and FIG. 2A again. In the step S12, the host 10 uses the operational processor 12 along with the memory 14 to execute an operational program P for performing a fusion algorithm P1, which is used for receiving the first optical scan image 202 produced by the optical scan unit 20, the first infrared image 252 produced by the infrared image extraction unit 25, and the first ambient image 302 produced by the image extraction unit 30, performing image fusion, and producing a first image IMG1. According to the present embodiment, since the ambience 90 contains the obstacle OB, the first image IMG1 will include an obstacle image OBI. The operational processor 12 executes the operational program P to perform pre-processes on the first optical scan image 202, the first infrared image 252, and the first ambient image 302. Thereby, the corresponding obstacle image OBI of the obstacle OB may be highlighted in the first image IMG1. Then perform image stitching as well as color and grayscale calibrations, the result is provided for subsequent spatial identification.

In the fusion algorithm P1, the characteristic function f(x, y) is first introduced, as shown in Equation (3). f(x, y) is a two-value function. When x and y satisfy a certain condition, the value of the characteristic function is 1.

$${f}_{i} ( x , y ) ∈ \{ 0 , 1 \} , i = 1 , 2 , … , m \qquad ( 3 )$$

In the operational environment of the real world, the hidden state of a certain observable is determined by the context (observation, state). Introducing the characteristic function enables us to freely choose characteristics (the combination of observation and state). It may be said that characteristics (the combination of observations) are used to replace observations for avoiding the generative model, for example, the hidden Markov model (HMM), be limited by the assumption of observational independence.

An empirical expected value and a model expected value may be obtained according to the training data D={(x,y)}.

$$\tilde{E} ( {f}_{i} ) = \frac{1}{n} {\sum }_{x , y} p ( x , y ) {f}_{i} ( x , y ) \qquad ( 4 )$$

$$E ( {f}_{i} ) = \frac{1}{n} {\sum }_{x , y} p ( x ) p ( y \vert x ) {f}_{i} ( x , y ) \qquad ( 5 )$$

Assume the empirical expected value and the model expected value are equal. Then there exists a set C of conditional probability distribution pertinent to multiple arbitrary characteristic functions fi satisfying the constraint.

$$C = \{ P \vert {E}_{p} ( {f}_{i} ) = \tilde{E} ( {f}_{i} ) , i = 1 , 2 , … , m \} \qquad ( 6 )$$

In the step S14, as shown in FIG. 2B, the host 10 uses the operational processor 12 to execute an image optical flow algorithm L for obtaining the obstacle image OBI according to the first image IMG1 and the obstacle information INFO of the obstacle OB according to the obstacle image. The obstacle information INFO includes a movement vector OBV1 and an acceleration vector OBV2 of the obstacle OB and a relative distance R between the obstacle OB and the vehicle V. Thereby, in the subsequent step S16, as shown in FIG. 2C, the host 10 uses the operational processor 12 to obtain the movement vector OBV1 and the acceleration vector OBV2 of the obstacle OB and the relative distance R between the obstacle OB and the vehicle V according to the obstacle information INFO. The first image IMG1 includes point-cloud image data. Likewise, the obstacle image OBI includes point-cloud image data as well. Consequently, all image processing according to the present embodiment is based on point-cloud image processing technologies. To calculate the movement vector OBV1 is equivalent to calculate the relative speed of the obstacle OB with respect to the vehicle V and the movement direction of the obstacle OB. Besides, the host 10 further uses the operational processor 12 to extract a positioning message 122 corresponding to the obstacle OB according to the obstacle information INFO used for obtaining the relative distance R between the obstacle OB and the vehicle V. In particular, by using the movement speed SPD of the vehicle V and the positioning message 122, the relative distance R between the obstacle OB and the vehicle V will be deduced.

In the step S18, as shown in FIG. 2D, the host 10 uses the operational processor 12 to judge whether the obstacle image OBI is located in the first image zone IMA1 or the second image zone IMA2 of the first image IMG1 according to a distance threshold TH and the relative distance R between the obstacle OB and the vehicle V and thereby judging whether the obstacle OB is located in the first detection zone A1 or the second detection zone A2 surrounding the vehicle V. The difference between the relative distance R and the distance threshold TH may approach zero, meaning that the obstacle OB is close to the distance threshold TH. The distance threshold TH is preset in the operational program P. It may be 5 to 50 meters. Particularly, the distance threshold TH may be 5 to 10 meters.

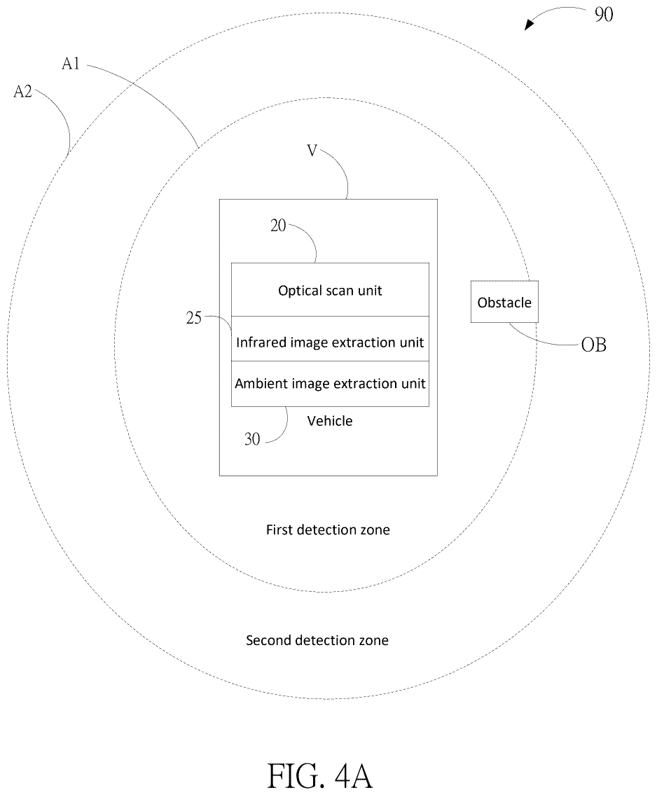

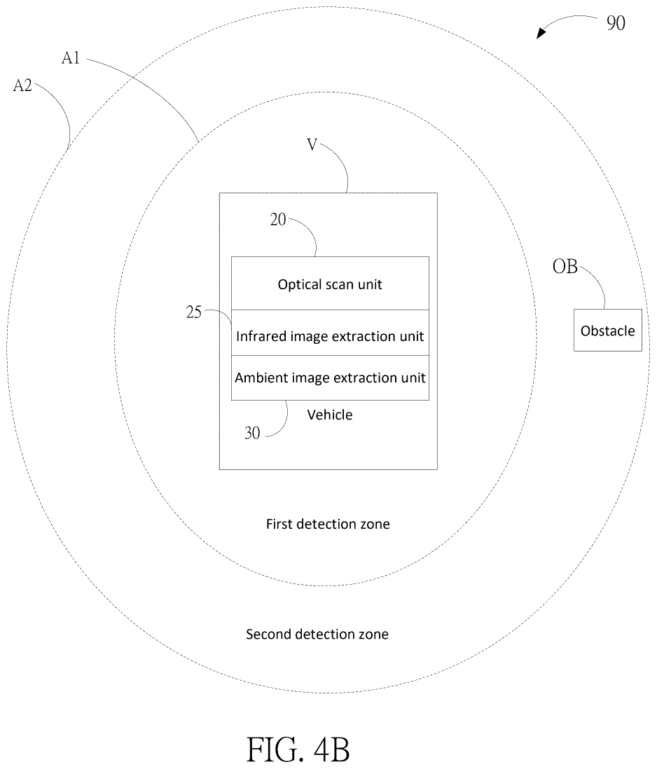

As shown in FIG. 2E and FIG. 4A, when the relative distance R is smaller than the distance threshold TH and the host 10 judges that the obstacle OB is located in the first detection zone A1 since the obstacle image OBI is located in the first image zone IMA1, the step S20 is then executed. The host 10 uses the operational processor 12 to produce the first alarm message M1 corresponding to the obstacle OB according to the movement speed SPD of the vehicle V and the movement vector OBV1 and the acceleration vector OBV2 of the obstacle OB. In addition to producing the first alarm message M1, with reference to the movement speed SPD of the vehicle V and the relative speed of the obstacle OB, a reminder to the driver may be obtained. The movement vector OBV1 corresponds to the relative speed of the obstacle OB with respect to the vehicle V and the movement direction of the obstacle OB. When the movement speed SPD of the vehicle V is smaller than the relative speed of the obstacle OB, the host 10 uses the operational processor 12 to further produce a brake prompt message XM. For example, remind the driver of watching out for lateral obstacle or oncoming traffic from the side. Furthermore, the brake prompt message XM may be utilized to warn the driver of braking.

Moreover, as shown in FIG. 2F and FIG. 4A, when the movement speed SPD of the vehicle V is greater than the relative speed of the obstacle OB, the host 10 uses the operational processor 12 to further judge that the driver in the vehicle V should be unable to react promptly. To prevent the vehicle V and the driver from unavoidable emergent accidents, the host 10 uses the operational processor 12 to further produce a brake control message SM and thereby controlling the vehicle V to brake. The host 10 still uses the operational processor 12 to produce the first alarm message M1 corresponding to the obstacle OB.

In addition, the host 10 may further execute the following step using the operational processor 12.

Please refer to FIG. 1 again. The mobile vehicle sensor fusion method according to the present application further comprises a step of:
Step S22: Using host producing second alarm message according to movement speed of vehicle and movement vector of obstacle.

When the relative distance R is greater than the distance threshold TH and the host 10 judges that the obstacle OB is located in the second detection zone A2 since the obstacle image OBI is located in the second image zone IMA2, then the step S22 is executed. As shown in FIG. 2G and FIG. 4B, the host 10 uses the operational processor 12 to produce a second alarm message M2 corresponding to the obstacle OB according to the movement speed SPD of the vehicle V and the movement vector OBV1 of the obstacle OB. The alarm level of the second alarm message M2 is lower than that of the first alarm message M1.

In the image processing executed by the operational program P, the equations of Sobel edge detection are described as follows.

### Sobel Edge Detection:

Each pixel in the image and its adjacent pixels are expressed in a matrix using P1, P2, P3, P4, . . . . P9 as expressed in Equation (7) below:

$$∇ f = \vert Gx \vert + \vert Gy \vert \qquad ( 7 )$$

$$[ \begin{matrix}P 1 & P 2 & P 3 \\ P 4 & P 5 & P 6 \\ P 7 & P 8 & P 9\end{matrix} ] \qquad ( 8 )$$

$$Gx = [ \begin{matrix}P 1 & P 2 & P 3 \\ P 4 & P 5 & P 6 \\ P 7 & P 8 & P 9\end{matrix} ] \qquad ( 9 )$$

$$Gy = [ \begin{matrix}P 1 & P 2 & P 3 \\ P 4 & P 5 & P 6 \\ P 7 & P 8 & P 9\end{matrix} ] \qquad ( 10 )$$

$$[ \begin{matrix}f ( x - 1 , y - 1 ) & f ( x , y - 1 ) & f ( x + 1 , y - 1 ) \\ f ( x - 1 , y ) & f ( x , y ) & f ( x + 1 , y ) \\ f ( x - 1 , y + 1 ) & f ( x , y + 1 ) & f ( x + 1 , y + 1 )\end{matrix} ] \qquad ( 11 )$$

$$E ( h , O ) = D ( O , h , C ) + {λ}_{k} * K c ( h ) \qquad ( 12 )$$

$$D ( O , h , C ) \frac{{Σ}_{min} ( \vert {o}_{d} - {r}_{d} \vert , {d}_{M} )}{Σ ( {o}_{s} ∨ {r}_{m} ) + ε} + λ ( 1 - \frac{2 Σ ( {o}_{s} ∧ {r}_{m} )}{Σ ( {o}_{s} ∧ {r}_{m} ) + Σ ( {o}_{s} ∨ {r}_{m} )} ) \qquad ( 13 )$$

R is the turning radius of the vehicle V; L is the wheelbase; d₁ is the front wheel spacing; d₂ is the rear wheel spacing; α is the angle between the line connecting the midpoints of front and rear wheel axles and the center of turning curvature; a is the moving radius of the centerline of the inner rear wheel; b is the moving radius of the centerline of the inner front wheel; and m is the difference of radius between inner wheels of a non-trailer.

The image optical flow algorithm L described above is the Lucas-Kanade optical flow algorithm used for estimating obstacles. First, the image difference method is adopted by using Taylor equations on the image constraint equation:

$$I ( x + δ x , y + δ y , z + δ z , t + δ t ) = I ( x , y , z , t ) + \frac{\partial I}{\partial x} δ x + \frac{\partial I}{\partial y} δ y + \frac{\partial I}{\partial z} δ z + \frac{\partial I}{\partial t} δ t + H . O . T . \qquad ( 14 )$$

Wherein H.O.T. means higher order terms and may be neglected for infinitesimal movement. According to this equation, it may be obtained as follow:

$$\frac{\partial I}{\partial x} δ x + \frac{\partial I}{\partial y} δ y + \frac{\partial I}{\partial z} δ z + \frac{\partial I}{\partial t} δ t = 0 \qquad ( 15 )$$

$$or$$

$$\frac{\partial I}{\partial x} \frac{δ x}{δ t} + \frac{\partial I}{\partial y} \frac{δ y}{δ t} + \frac{\partial I}{\partial z} \frac{δ z}{δ t} + \frac{\partial I}{\partial t} \frac{δ t}{δ t} = 0 \qquad ( 16 )$$

and obtaining:

$$\frac{\partial I}{\partial x} {V}_{x} + \frac{\partial I}{\partial y} {V}_{y} + \frac{\partial I}{\partial z} {V}_{z} + \frac{\partial I}{\partial t} = 0 \qquad ( 17 )$$

Vₓ, V_{y}, V_{z} are the x, y, z components of the optical flow vector of I(x,y,z,t), respectively.

$$\frac{\partial I}{\partial x} , \frac{\partial I}{\partial y} , \frac{\partial I}{\partial z} and \frac{\partial I}{\partial t}$$

are the differences of the pixel (x,y,z,t) with respect to the corresponding directions. Thereby, Equation (17) may be converted to the following equation:

$${I}_{x} {V}_{x} + {I}_{y} {V}_{y} + {I}_{z} {V}_{z} = - {I}_{t} \qquad ( 18 )$$

Furthermore, rewrite Equation (18) as the following equation:

$$∇ {I}^{T} \cdot \vec{V} = - {I}_{t} \qquad ( 19 )$$

Since there are three unknowns (Vₓ, V_{y}, V_{z}) in Equation (18), the subsequent algorithm will solve the unknowns.

First, assuming that the optical flow (Vₓ, V_{y}, V_{z}) is a constant in a small box with the size m*m*m (m>1), then a system of equations may be obtained for the voxels 1 . . . n, n=m³:

$$\begin{matrix}{I}_{{x}_{1}} {V}_{x} + {I}_{{y}_{1}} {V}_{y} + {I}_{{z}_{1}} {V}_{z} = - {I}_{{t}_{1}} \\ {I}_{{x}_{2}} {V}_{x} + {I}_{{y}_{2}} {V}_{y} + {I}_{{z}_{2}} {V}_{z} = - {I}_{{t}_{2}} \\ ⋮ \\ {I}_{{x}_{n}} {V}_{x} + {I}_{{y}_{n}} {V}_{y} + {I}_{{z}_{n}} {V}_{z} = - {I}_{{t}_{n}}\end{matrix} \qquad ( 20 )$$

All the above equations include three unknowns and hence form an over-determined system of equations, meaning the existence of redundance in the system of equations. The system of equations may be expressed as:

$$[ \begin{matrix}{I}_{{x}_{1}} & {I}_{{y}_{1}} & {I}_{{z}_{1}} \\ {I}_{{x}_{2}} & {I}_{{y}_{2}} & {I}_{{z}_{2}} \\ ⋮ & ⋮ & ⋮ \\ {I}_{{x}_{n}} & {I}_{{y}_{n}} & {I}_{{z}_{n}}\end{matrix} ] [ \begin{matrix}{V}_{x} \\ {V}_{y} \\ {V}_{z}\end{matrix} ] = [ \begin{matrix}- {I}_{{t}_{1}} \\ - {I}_{{t}_{2}} \\ ⋮ \\ - {I}_{{t}_{n}}\end{matrix} ] \qquad ( 21 )$$

Denoted as:

$$A \vec{v} = - b \qquad ( 22 )$$

To solve this over-determined problem, adopt the least squares method on Equation (16) to obtain:

$${A}^{T} A \vec{v} = {A}^{T} ( - b ) \qquad ( 23 )$$

$$or$$

$$\vec{v} = {( {A}^{T} A )}^{- 1} {A}^{T} ( - b ) \qquad ( 24 )$$

Obtaining:

$$[ \begin{matrix}{V}_{x} \\ {V}_{y} \\ {V}_{z}\end{matrix} ] = [ \begin{matrix}\sum {I}_{\text{?}}^{2} & \sum {I}_{\text{?}} {I}_{\text{?}} & \sum {I}_{\text{?}} {I}_{\text{?}} \\ \sum {I}_{\text{?}} {I}_{\text{?}} & \sum {I}_{\text{?}}^{2} & \sum {I}_{\text{?}} {I}_{\text{?}} \\ \sum {I}_{\text{?}} {I}_{\text{?}} & \sum {I}_{\text{?}} {I}_{\text{?}} & \sum {I}_{\text{?}}^{2}\end{matrix} ] [ \begin{matrix}- \sum {I}_{\text{?}} {I}_{\text{?}} \\ - \sum {I}_{\text{?}} {I}_{\text{?}} \\ - \sum {I}_{\text{?}} {I}_{\text{?}}\end{matrix} ] \qquad ( 25 )$$

$$\text{?} \text{indicates text missing or illegible when filed}$$

Substituting the result of Equation (25) into Equation (17), an acceleration vector of the target object and a relative distance between the target object and the vehicle may be estimated for classifying and predicting the movement path of the target object.

According to the maximum entropy principle, the only reasonable probability distribution derived from incomplete information (such as a limited amount of training data) should possess the maximum entropy value while satisfying the constraints provided by this information. That is, the distribution with maximum entropy is optimal in the conditional probability set. Thereby, the maximum entropy model becomes a constrained optimization problem of convex functions.

$${max}_{P ϵ C} H ( P ) = - {\sum }_{x , y} P ( x ) P ( y \vert x ) log P ( y \vert x ) \qquad ( 26 )$$

$$s . t . {E}_{p} ( {f}_{i} ) = {\tilde{E}}_{p} ( {f}_{i} ) , i = 1 , 2 , … , m \qquad ( 27 )$$

$$s . t . {\sum }_{y} p ( y \vert x ) = 1 \qquad ( 28 )$$

The Lagrangian duality principle is usually adopted to transform the original formula into an unconstrained extreme value problem.

$$L ( ω , α , β ) = f ( ω ) + {\sum }_{i = 1}^{k} {α}_{i} {g}_{i} ( ω ) + {\sum }_{j = 1}^{l} {β}_{j} {h}_{j} ( ω ) \qquad ( 29 )$$

$$Λ ( p , \tilde{λ} ) = H ( y \vert x ) + {\sum }_{i = 1}^{m} {λ}_{i} ( {E}_{p} ( {f}_{i} ) - {\tilde{E}}_{p} ( {f}_{i} ) ) + {λ}_{m + 1} ( {\sum }_{y ϵ𝒴} P ( y \vert x ) - 1 ) \qquad ( 30 )$$

Find the partial derivative of p in the Lagrangian function, make it equal to 0, and solve the equation. By omitting the intermediate steps and rearranging terms, one may get the following equations:

$${p}_{\overline{λ}}^{*} ( y \vert x ) = \frac{1}{{Z}_{\overline{λ}} ( x )} exp ( {\sum }_{i = 1}^{m} {λ}_{i} {f}_{i} ( x , y ) ) \qquad ( 31 )$$

$${Z}_{\overline{λ}} ( x ) = {\sum }_{y ϵ𝒴} exp ( {\sum }_{i = 1}^{m} {λ}_{i} {f}_{i} ( x , y ) ) \qquad ( 32 )$$

The maximum-entropy Markov model (MEMM)

$${\begin{matrix}{p}_{{y}_{i - 1}} ( {y}_{i} \vert {x}_{i} ) = \frac{1}{{Z}_{\overline{λ}} ( {x}_{i} , {y}_{i - 1} )} exp ( {\sum }_{a}^{m} {λ}_{a} {f}_{a} ( {x}_{i} , {y}_{i} ) ) , i = 1 , 2 , … , T & ( 33 )\end{matrix}}_{}$$

Use p(yᵢ|yᵢ₋₁,xᵢ) distribution to replace the two conditional probability distributions in HMM. It represents the probability of the current state from the previous state obtained the observation value. Namely, it predicts the current state based on the previous state and the current observation. Each such distribution function p_{yi-1}(yᵢ|xᵢ) is an exponential model that satisfies maximum entropy.

Assume the points {p₁, p₂ . . . , pₙ} on the discrete probability distribution and the maximum entropy are found. Find the probability distribution {p₁, p₂ . . . , pₙ} with minimum deviation. The maximum entropy formula:

$$f ( {p}_{1} , {p}_{2} , … {p}_{n} ) = - {\sum }_{j = 1}^{n} {P}_{j} \cdot {log}_{2} {P}_{j} \qquad ( 34 )$$

The sum of the probability pᵢ at each point xᵢ in the probability distribution must be equal to 1:

$$g ( {p}_{1} , {p}_{2} , … , {p}_{n} ) = {\sum }_{j = 1}^{n} {p}_{j} = 1. \qquad ( 35 )$$

We use Lagrange multipliers to find the angle of maximum entropy. \vec{p} encompasses all {x₁, x₂ . . . , xₙ} on the discrete probability distribution \vec{p}. Demand:

$$\frac{\partial }{\partial {p}^{\text{?}}} ( f + λ ( g - 1 ) ) {\vert}_{{p}^{\text{?}} = {p}^{\text{?}} \text{?}} = 0 , \qquad ( 36 )$$

$$\text{?} \text{indicates text missing or illegible when filed}$$

Obtaining a system of equations with k=1, . . . n:

$$\frac{\partial }{\partial {p}_{k}} \{ - ( {\sum }_{j = 1}^{n} {p}_{j} {log}_{2} {p}_{j} ) + λ ( {\sum }_{j = 1}^{n} {p}_{j} - 1 ) \} {\vert}_{{p}_{\text{?}} = {p}_{\text{?}}^{\text{?}}} = 0. \qquad ( 37 )$$

$$\text{?} \text{indicates text missing or illegible when filed}$$

By expanding these equations, one obtains:

$$- ( \frac{1}{ln 2} + {log}_{2} {p}_{k}^{*} ) + λ = 0. \qquad ( 38 )$$

This means that all pₖ* are equal because they rely on λ only. By applying the constraint:

$${\sum }_{j} {p}_{j} = 1 , {p}_{k}^{*} = \frac{1}{n} . \qquad ( 39 )$$

one obtains

$${p}_{k}^{*} = \frac{1}{n} . \qquad ( 40 )$$

Thereby, the uniform distribution is the distribution with the maximum entropy.

$$Accuracy = \vert \frac{{\sum }_{i = 1}^{n} {P}_{j} - {P}_{k}}{{\sum }_{j = 1}^{n} {P}_{j}} \vert \times 100 \qquad ( 41 )$$

To sum up, the mobile vehicle sensor fusion system and the method thereof according to the present application provide a host to obtain object images of a plurality obstacles on a side of a vehicle. The object images are classified according to a relative distance between the target object and the vehicle. Then predictive calculations may be performed on the filtered image corresponding to the obstacle to obtain the predicted movement path. The predicted movement path may be calculated with the corresponding movement data from the movement path of the vehicle for producing alarm messages. Besides, the host may further adjust the movement data according to the obstacle to avoid danger.

Accordingly, the present application conforms to the legal requirements owing to its novelty, nonobviousness, and utility. However, the foregoing description is only embodiments of the present application, not used to limit the scope and range of the present application. Those equivalent changes or modifications made according to the shape, structure, feature, or spirit described in the claims of the present application are included in the appended claims of the present application.

1. A mobile vehicle sensor fusion method, applied to a vehicle moving at a movement speed, said vehicle including a host, an optical scan unit, an infrared image extraction unit, and an image extraction unit, said host connected electrically to said optical scan unit, said infrared image extraction unit, and said image extraction unit, and comprising steps of:
using said optical scan unit, said infrared image extraction unit, and said image extraction unit extracting a first scan image, a first infrared image, a first ambient image, respectively, according to a first detection zone and a second detection zone surrounding said vehicle, said optical scan unit and said image extraction unit transmitting said first scan image and said first ambient image to said host, and said first detection zone located between said vehicle and said second detection zone;
using said host executing a fusion algorithm according to the first scan image, said first infrared image, and said first ambient image for obtaining a first image, said first image including a first image zone and a second image zone, said first image zone and said second image zone having different depths of field, said first image zone corresponding to said first detection zone, and said second image zone corresponding to said second detection zone;
using said host executing an image optical flow algorithm according to said first image for obtaining an obstacle image, and obtaining obstacle information of an obstacle according to said obstacle image;
using said host obtaining a movement vector and an acceleration vector of said obstacle and a relative distance between said obstacle and said vehicle according to said obstacle information;
using said host judging whether said obstacle is located in said first detection zone or said second detection zone surrounding said vehicle according to said relative distance and a distance threshold; and
when said relative distance is smaller than or equal to said distance threshold and said obstacle is judged to be in said first detection zone since said obstacle image is located in said first image zone, using said host producing a first alarm message corresponding to said obstacle according to said movement speed of said vehicle and said movement vector and said acceleration vector of said obstacle.

2. The mobile vehicle sensor fusion method of claim 1, wherein in said step of using said host producing a first alarm message corresponding to said obstacle according to said movement speed of said vehicle and said movement vector and said acceleration vector of said obstacle, said movement vector corresponds to a relative speed of said obstacle with respect to said vehicle and a movement direction of said obstacle; when said movement speed is smaller than said relative speed, said host further produces a brake prompt message; and when said movement speed is greater than said relative speed, said host further drives said vehicle to brake.

3. The mobile vehicle sensor fusion method of claim 1, wherein in said step of using said host obtaining a relative distance between said obstacle and said vehicle according to said obstacle information and judging whether said obstacle is located in said first detection zone or said second detection zone of said vehicle according to said movement speed, said relative distance, and a distance threshold, said host extracts a positioning message corresponding to said obstacle according to said obstacle information for obtaining said relative distance between said obstacle and said vehicle.

4. The mobile vehicle sensor fusion method of claim 1, wherein in said step of using said host obtaining a relative distance between said obstacle and said vehicle according to said obstacle information and judging whether said obstacle is located in said first detection zone or said second detection zone of said vehicle according to said relative distance and a distance threshold, said distance threshold is 5 meters to 10 meters.

5. The mobile vehicle sensor fusion method of claim 1, further comprising a step of: when said relative distance is greater than said distance threshold and said obstacle is judged to be in said second detection zone since said obstacle image is located in said second image zone, said host producing a second alarm message corresponding to said obstacle according to said movement speed of said vehicle and said movement vector of said obstacle, and the alarm level of said second alarm message being lower than that of said first alarm message.

6. A mobile vehicle sensor fusion system, applied to a vehicle, said vehicle moving at a movement speed, and comprising:
a host, disposed in said vehicle;
an optical scan unit, disposed in said vehicle and connected electrically to said host, extracting and transmitting a first scan image according to a first detection zone and a second detection zone surrounding said vehicle to said host, and said first detection zone located between said vehicle and said second detection zone; and
an image extraction unit, disposed in said vehicle and connected electrically to said host, extracting and transmitting a first ambient image according to said first detection zone and said second detection zone surrounding said vehicle to said host, said host executing a fusion algorithm according to said first scan image and said first ambient image for obtaining a first image, and said first image including a first image zone and a second image zone with said first image zone corresponding to said first detection zone and said second image zone corresponding to said second detection zone;
wherein said host executes an image optical flow algorithm according to said first image for obtaining an obstacle image and obtaining obstacle information of an obstacle according to said obstacle image; said host obtains a movement vector and an acceleration vector of said obstacle and a relative distance between said obstacle and said vehicle according to said obstacle information, and judges whether said obstacle is located in said first detection zone or said second detection zone surrounding said vehicle according to said relative distance and a distance threshold; when said relative distance is smaller than or equal to said distance threshold and said obstacle is judged to be in said first detection zone since said obstacle image is located in said first image zone, said host produces a first alarm message corresponding to said obstacle according to the movement speed of said vehicle and said movement vector and said acceleration vector of said obstacle.

7. The mobile vehicle sensor fusion system of claim 6, wherein said distance threshold is 5 meters to 10 meters.

8. The mobile vehicle sensor fusion system of claim 6, wherein said movement vector corresponds to a relative speed of said obstacle with respect to said vehicle and a movement direction of said obstacle; when said movement speed is smaller than said relative speed, said host further produces a brake prompt message; and when said movement speed is greater than said relative speed, said host further drives said vehicle to brake.

9. The mobile vehicle sensor fusion system of claim 6, wherein said host extracts a positioning message corresponding to said obstacle according to said obstacle information for obtaining said relative distance between said obstacle and said vehicle.

10. The mobile vehicle sensor fusion system of claim 6, wherein when said relative distance is greater than said distance threshold and said obstacle is judged to be in said second detection zone since said obstacle image is located in said second image zone, said host produces a second alarm message corresponding to said obstacle according to said movement speed of said vehicle and said movement vector of said obstacle, and the alarm level of said second alarm message is lower than that of said first alarm message.
